(19) United States
(12) Patent Application Publication
(10) Pub. No.: US 2025/0042226 A1
(43) Pub. Date: Feb. 6, 2025

(54) AIR BLOWING STRUCTURE

(71) Applicant: HONDA MOTOR CO., LTD., Tokyo (JP)

(72) Inventor: Yu NAKASHIMA, Tokyo (JP)

(21) Appl. No.: 18/791,463

(22) Filed: Aug. 1, 2024

(30) Foreign Application Priority Data
Aug. 2, 2023 (CN) 202310962348.8

(51) Int. Cl. B60H 1/34

(52) U.S. Cl. CPC B60H 1/3414

(57) ABSTRACT

To provide an air blowing structure having an excellent aesthetic appearance. An air blowing structure (1) includes an outlet (11) for supplying conditioned air to a vehicle interior (101). The air blowing structure (1) includes an upper panel (41), a lower panel (45), an upper flow path (16) through which conditioned air passes, and a lower flow path (18) that is provided below the upper flow path (16) and through which conditioned air passes. The upper flow path (16) includes an upper opening (17) that opens downward and supplies conditioned air to the vehicle interior (101) through the outlet (11). The lower flow path (18) includes a lower opening (19) that opens upward and that supplies conditioned air to the vehicle interior (101) through the outlet (11). The lower opening (19) has an opening area smaller than an opening area of the upper opening (17).

This application is based on and claims the benefit of priority from Chinese Patent Application No. 202310962348.8, filed on 2 Aug. 2023, the content of which is incorporated herein by reference.

### BACKGROUND OF THE INVENTION

### Field of the Invention

The present invention relates to an air blowing structure.

### Related Art

There is an air blowing structure where a direction in which air is blown from an outlet can be adjusted up and down.

For example, in the air blowing structure of Patent Document 1, an upper center register for blowing air downward and a lower center register for blowing air upward are provided in a recess formed in an instrument panel. According to the air blowing structure, the air blowing direction can be adjusted up and down by controlling the air volume distribution between the center registers. The center registers are respectively provided on the upper and lower surfaces of the recess so as to be less visible to the driver.
Patent Document 1: Japanese Unexamined Patent Application, Publication No. 2004-114816

### SUMMARY OF THE INVENTION

However, regarding the air blowing structure, it is considered that the lower center register is visible to the driver.

In response to the above issue, an object of the present invention is to provide an air blowing structure having an excellent aesthetic appearance.

A first aspect of the present invention relates to an air blowing structure including an outlet for supplying air to a vehicle interior of a vehicle. Among directions orthogonal to an up-down direction, a direction in which the air blows out from the outlet is a downstream direction, and a direction opposite to the downstream direction is an upstream direction. The air blowing structure further includes an upper panel constituting an upper edge of an opening of the outlet, a lower panel constituting a lower edge of the opening of the outlet, an upper flow path through which the air passes, and a lower flow path that is provided below the upper flow path and through which the air passes. The upper flow path includes an upper opening that opens downward and that supplies the air to the vehicle interior through the outlet. The lower flow path includes a lower opening that opens upward and that supplies the air to the vehicle interior through the outlet. The lower opening has an opening area smaller than an opening area of the upper opening.

According to the first aspect, by reducing the opening area of the lower opening, it is possible to suppress the opening of the lower opening from being visible to the driver or the like. This can provide an air blowing structure 1 having an excellent aesthetic appearance.

In a second aspect according to the first aspect, the lower opening may include a return part protruding in the upstream direction.

According to the second aspect, it is possible to make the opening of the lower opening less visible to the driver or the like. Furthermore, the upward directivity of the conditioned air blown out from the lower opening can be enhanced.

In a third aspect according to the second aspect, at least a part of the upper panel may be located in the downstream direction with respect to the return part.

According to the third aspect, it is possible to suppress the opening of the lower opening from being visible to the driver or the like.

In a fourth aspect according to any one of the first to third aspects, the lower panel may include an inclined surface that extends downward and in the downstream direction from an opening periphery of the outlet.

According to the fourth aspect, air blowing out downward from the outlet is attracted to the inclined surface by the Coanda effect. This can enhance the downward directivity of the air.

In a fifth aspect according to any one of the first to fourth aspects, the air blowing structure may further include a curved surface that is provided between the upper opening and the lower opening in the upstream direction with respect to the outlet and that is curved in a convex shape in the downstream direction.

According to the fifth aspect, conditioned air blown upward is attracted to the lower part of the curved surface by the Coanda effect. This can enhance the upward directivity of the conditioned air. Conditioned air blown downward is attracted to the upper part of the curved surface. This can enhance the downward directivity of the conditioned air.

In a sixth aspect according to the fifth aspect, the air blowing structure may further include a lower fin that is provided in the lower flow path and that changes a direction of flow of the air. The lower fin may have an end in the downstream direction that is located in the upstream direction with respect to the curved surface.

According to the sixth aspect, it is possible to suppress the lower fin from being visible to the driver or the like.

In a seventh aspect according to the fifth or sixth aspect, the curved surface may include a decorative part. The upper panel may include a light projector that projects light toward the decorative part.

According to the seventh aspect, the design of the air blowing structure 1 can be enhanced. In addition, it is possible to attract the attention of the driver or the like to the decorative surface and make the other parts relatively inconspicuous.

According to the present invention, it is possible to provide an air blowing structure having an excellent aesthetic appearance.

### BRIEF DESCRIPTION OF THE DRAWINGS

FIG. 1 is a longitudinal sectional view showing an air blowing structure according to an embodiment;

FIG. 2 is an external view of a cover of the air blowing structure as viewed from a vehicle interior side;

FIG. 3 is a schematic diagram showing a flow of conditioned air when an up-down fin is in a first state;

FIG. 4 is a schematic diagram showing a flow of conditioned air when the up-down fin is in a second state;

FIG. 5 is a schematic diagram showing a flow of conditioned air when the up-down fin is in a third state; and

FIG. 6 is a schematic diagram showing a flow of conditioned air when the up-down fin is in a fourth state.

### DETAILED DESCRIPTION OF THE INVENTION

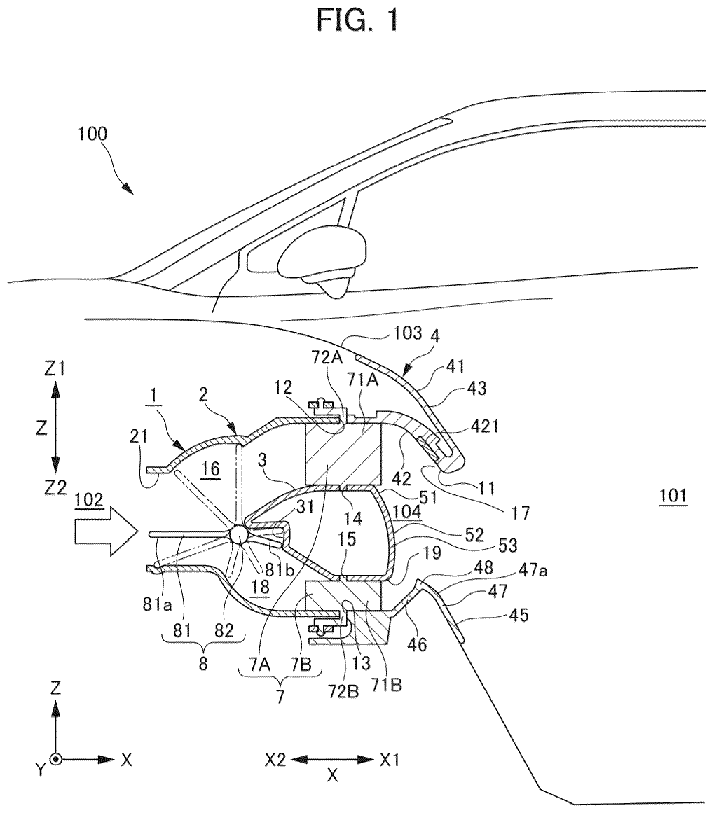

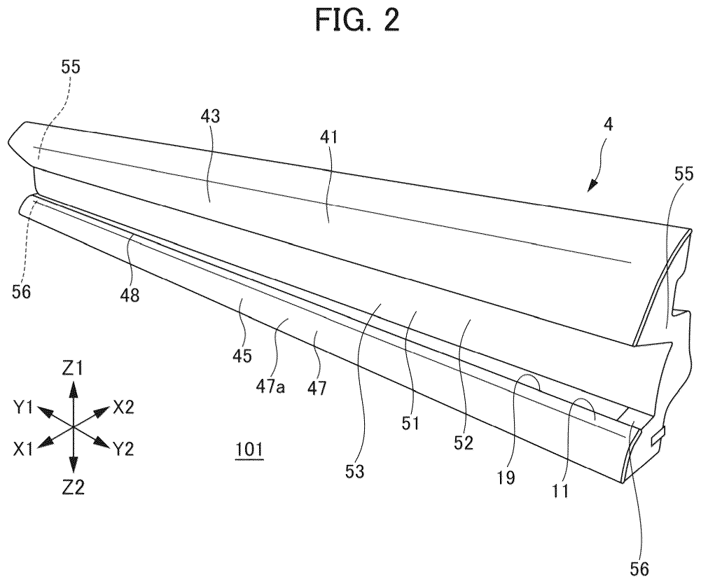

Hereinafter, an air blowing structure 1 according to an embodiment of the present invention will be described with reference to FIGS. 1 and 2. FIG. 1 is a longitudinal sectional view showing the air blowing structure 1 according to the embodiment. FIG. 2 is an external view of a cover 4 of the air blowing structure 1 as viewed from the side of a vehicle interior 101. The air blowing structure 1 is provided in a vehicle 100. The air blowing structure 1 includes an outlet 11. The outlet 11 supplies conditioned air to the vehicle interior 101 of the vehicle 100.

In the following description, the front-rear direction viewed from the driver (that is, the vehicle length direction of the vehicle 100) is defined as the front-rear direction, the left-right direction viewed from the driver (that is, the vehicle width direction of the vehicle 100) is defined as the left-right direction, and the up-down direction viewed from the driver (that is, the vehicle height direction of the vehicle 100) is defined as the up-down direction.

In the drawings, the front-rear direction is defined as an X coordinate axis, the rear direction is defined as X1, and the front direction is defined as X2. The left-right direction is defined as a Y coordinate axis, the left direction is defined as Y1, and the right direction is defined as Y2. The up-down direction is defined as a Z coordinate axis, the upward direction is defined as Z1, and the downward direction is defined as Z2.

As shown in FIG. 1, a vehicle 100 includes a vehicle interior 101, an air conditioning device (not shown) that generates conditioned air, a duct 102 that extends from the air conditioning device, and an air blowing structure 1 that is connected to the duct 102.

An instrument panel 103 is provided on the front side of the vehicle interior 101. The instrument panel 103 is provided with a recess 104 recessed forward. An end of the duct 102 on the vehicle interior 101 side extends to the back side of the recess 104. Although not shown, the opening shape of the recess 104 is a rectangular shape extending in the left-right direction when viewed from the vehicle interior 101 side.

The air blowing structure 1 is provided in the recess 104. The air blowing structure 1 includes a case 2, a partition 3, a cover 4, an outlet 11, a left-right fin 7, and an up-down fin 8. Conditioned air is blown out rearward from the outlet 11. Therefore, in the present embodiment, the rear direction corresponds to the downstream direction, and the front direction corresponds to the upstream direction.

The case 2 is provided inside the recess 104. The case 2 has a hollow box shape. Although not shown, the case 2 has a rectangular shape extending in the left-right direction when viewed from the vehicle interior 101 side. The front side surface of the case 2 is provided with an inlet 21 for taking in conditioned air. The duct 102 is connected to the inlet 21. The inside of the duct 102 communicates with the inside of the case 2. The conditioned air flowing down the duct 102 flows into the air blowing structure 1 (case 2) through the inlet 21. The rear side surface of the case 2 is an opening surface.

The partition 3 is provided inside the case 2. The partition 3 partitions the internal space of the case 2 into upper and lower spaces. The partition 3 has a substantially triangular shape protruding forward when viewed in the left-right direction. Although not shown, the partition 3 extends in the left-right direction. In the internal space of the case 2, the space above the partition 3 is wider than the space below the partition 3. The partition 3 includes a recessed part 31 that is recessed rearward and upward in a forward and downward part.

The cover 4 is provided on the rear side of the case 2. As shown in FIG. 2, the cover 4 has an elongated shape extending in the left-right direction. The cover 4 is attached to the rear side surface of the case 2 and the opening periphery of the recess 104 on the vehicle interior 101 side. The cover 4 includes an upper panel 41 and a lower panel 45 that form a pair in the up-down direction, an intermediate panel 51 disposed between the upper panel 41 and the lower panel 45, an upper connecting part 55 that connects the upper panel 41 and the intermediate panel 51, and a lower connecting part 56 that connects the lower panel 45 and the intermediate panel 51. The intermediate panel 51 is disposed forward of the upper panel 41 and the lower panel 45.

The upper panel 41 is disposed along the upper edge of the opening periphery of the recess 104. The upper panel 41 is connected to the upper part of the rear side surface of the case 2. The upper panel 41 extends in the left-right direction. The upper panel 41 includes a first upper inclined part 42 extending rearward and downward from the case 2 side, and a second upper inclined part 43 rising upward and extending forward from the rear end of the first upper inclined part 42. The connecting part between the first upper inclined part 42 and the second upper inclined part 43 constitutes the upper edge of the opening periphery of the outlet 11.

The first upper inclined part 42 constitutes a part of the peripheral wall of an upper flow path 16 described later. The second upper inclined part 43 is exposed to the vehicle interior 101.

In the connecting part between the upper panel 41 and the case 2, a hole 12 penetrating the connecting part in the up-down direction is provided. Although not shown, a plurality of holes 12 are provided side by side in the left-right direction.

The lower panel 45 is disposed along the lower edge of the opening periphery of the recess 104. The lower panel 45 is attached to the lower part of the rear side surface of the case 2. The lower panel 45 extends in the left-right direction. The lower panel 45 includes a first lower inclined part 46 extending rearward and upward from the case 2 and a second lower inclined part 47 extending rearward and downward from the rear end of the first lower inclined part 46. The connecting part between the first lower inclined part 46 and the second lower inclined part 47 constitutes the lower edge of the opening periphery of the outlet 11.

The first lower inclined part 46 constitutes a part of the peripheral wall of a lower flow path 18 described later.

The rear side surface of the second lower inclined part 47 is exposed to the vehicle interior 101. The rear side surface of the second lower inclined part 47 is an inclined surface 47a that extends downward and rearward from the upper end thereof (that is, the opening periphery of the outlet 11). In other words, the lower panel 45 includes an inclined surface 47a that extends downward and rearward from the opening periphery of the outlet 11. The inclined surface 47a is slightly curved upward and rearward in a convex shape.

In the connecting part between the lower panel 45 and the case 2, a hole 13 penetrating the connecting part in the up-down direction is provided. Although not shown, a plurality of holes 13 are provided side by side in the left-right direction.

The intermediate panel 51 is attached to the rear side of the partition 3. The intermediate panel 51 extends in the left-right direction. The dimension of the intermediate panel 51 in the up-down direction is substantially the same as the dimension of the partition 3 in the up-down direction.

The intermediate panel 51 has a curved surface 52 on the rear side thereof. The curved surface 52 is curved such that an intermediate part thereof in the up-down direction is convex rearward. The curved surface 52 is located forward of the upper panel 41 and the lower panel 45. The curved surface 52 can be visually recognized by a driver or a passenger (hereinafter, referred to as “driver or the like”). Here, the curved surface 52 includes a decorative part 53.

The decorative part 53 is, for example, a patterned panel, and is provided so as to cover the entire surface of the curved surface 52. This can enhance the design of the air blowing structure 1. In addition, the attention of the driver or the like can be drawn to the decorative part 53, making the other parts relatively inconspicuous. The decorative part 53 is not limited to a patterned panel, and may be, for example, a display.

The upper panel 41 includes a light projector 421 that projects light to the curved surface 52 (specifically, the decorative part 53). The light projector 421 is provided in the first upper inclined part 42. The light projector 421 is, for example, an LED. This allows the decorative part 53 to be illuminated and emphasized, further enhancing the design of the air blowing structure 1 and more suitably attracting the attention of the driver or the like to the decorative part 53. The light projector 421 may emit light of a single color, may emit light of a plurality of colors, or may be a projector that projects an image.

In the connecting part between the upper part of the intermediate panel 51 and the upper part of the partition 3, a hole 14 penetrating the connecting part in the up-down direction is provided. A plurality of holes 14 are provided side by side in the left-right direction. The holes 12 and the holes 14 are provided at positions overlapping each other as viewed in the up-down direction.

In the connecting part between the lower part of the intermediate panel 51 and the lower part of the partition 3, a hole 15 penetrating the connecting part in the up-down direction is provided. A plurality of holes 15 are provided side by side in the left-right direction. The holes 13 and the holes 15 are provided at positions overlapping each other as viewed in the up-down direction.

The upper connecting parts 55 are provided as a pair on the left and right sides. The upper connecting parts 55 respectively connect the ends of the upper panel 41 in the left-right direction to the ends of the intermediate panel 51 in the left-right direction. An intermediate part of the upper panel 41 in the left-right direction and an intermediate part of the intermediate panel 51 in the left-right direction are separated from each other. Therefore, the cover 4 has a space surrounded by the upper panel 41, the intermediate panel 51, and the upper connecting parts 55.

The space surrounded by the upper panel 41, the intermediate panel 51, and the upper connecting parts 55 is open rearward. An opening having the opening is hereinafter referred to as an “upper opening 17”. The upper opening 17 opens downward. The space surrounded by the upper panel 41, the intermediate panel 51, and the upper connecting parts 55 and the space above the partition 3 in the internal space of the case 2 form one continuous space, and conditioned air flows down in the space. The space formed by the space surrounded by the upper panel 41, the intermediate panel 51, and the upper connecting parts 55 and the space above the partition 3 in the internal space of the case 2, including a peripheral wall surrounding the space, is referred to as an “upper flow path 16”. In other words, the air blowing structure 1 includes the upper flow path 16 through which conditioned air passes, and the upper flow path 16 includes the upper opening 17 that opens downward. The peripheral wall of the upper flow path 16 includes the first upper inclined part 42 and the upper part of the curved surface 52.

The lower connecting parts 56 are provided as a pair on the left and right sides. The lower connecting parts 56 respectively connect the ends of the lower panel 45 in the left-right direction to the ends of the intermediate panel 51 in the left-right direction. An intermediate part of the lower panel 45 in the left-right direction and an intermediate part of the intermediate panel 51 in the left-right direction are separated from each other. Therefore, in the cover 4, a space surrounded by the lower panel 45, the intermediate panel 51, and the lower connecting parts 56 is formed.

The space surrounded by the lower panel 45, the intermediate panel 51, and the lower connecting parts 56 is open rearward. An opening having the opening is hereinafter referred to as a “lower opening 19”. The lower opening 19 opens upward. The space surrounded by the lower panel 45, the intermediate panel 51, and the lower connecting parts 56 and the space below the partition 3 in the internal space of the case 2 form one continuous space, and conditioned air flows down the space. The space formed by the space surrounded by the lower panel 45, the intermediate panel 51, and the lower connecting parts 56 and the space below the partition 3 in the internal space of the case 2, including a peripheral wall surrounding the space, is referred to as a “lower flow path 18”. In other words, the air blowing structure 1 includes the lower flow path 18 that is provided below the upper flow path 16 and through which conditioned air passes, and the lower flow path 18 includes the lower opening 19 that opens upward. The lower flow path 18 is narrower than the upper flow path 16. Therefore, the flow rate of conditioned air in the lower flow path 18 is smaller than the flow rate of conditioned air in the upper flow path 16. The peripheral wall of the lower flow path 18 includes the first lower inclined part 46 and the lower part of the curved surface 52.

The outlet 11 is provided in the cover 4. The opening shape of the outlet 11 is a substantially rectangular shape extending in the left-right direction. An upper edge of an opening periphery of the outlet 11 is constituted by the upper panel 41. A lower edge of the opening periphery of the outlet 11 is constituted by the lower panel 45. The outlet 11, the upper opening 17, and the lower opening 19 are spatially continuous. Therefore, the conditioned air blown out from the upper opening 17 and the conditioned air blown out from the lower opening 19 are supplied into the vehicle interior 101 through the outlet 11.

Here, if the lower opening 19 is visible to the driver or the like through the outlet 11, the aesthetic appearance of the air blowing structure 1 may be impaired.

Therefore, the opening area of the lower opening 19 is smaller than the opening area of the upper opening 17. By making the opening area of the lower opening 19 smaller, it is possible to suppress the lower opening 19 from being visible to the driver or the like.

Furthermore, the lower opening 19 includes a return part 48 protruding forward from an opening periphery of the lower opening 19. The return part 48 is provided on the lower panel 45, and more specifically, protrudes forward and upward from the rear end of the first lower inclined part 46. Thus, it is possible to suppress the opening of the lower opening 19 from being visible to the driver or the like.

Furthermore, at least a part of the upper panel 41 is located rearward of the return part 48, and more specifically, the lower end of the upper panel 41 (that is, the lower end of the first upper inclined part 42) is located rearward of the return part 48. This can suppress the opening of the lower opening 19 from being visible to the driver or the like.

The left-right fin 7 adjusts the direction of flow of conditioned air to the left and right. The left-right fin 7 includes a blade 71 that is formed in a rectangular plate shape and whose plate surface is disposed along the up-down direction, and a rotation shaft 72 that passes through the blade 71 and rotates about a central axis line extending in the up-down direction.

The left-right fin 7 includes an upper left-right fin 7A disposed in the upper flow path 16, and a lower left-right fin 7B disposed in the lower flow path 18. The blade 71 and the rotation shaft 72 of the upper left-right fin 7A are referred to as a blade 71A and a rotation shaft 72A. The blade 71 and the rotation shaft 72 of the lower left-right fin 7B are referred to as a blade 71B and a rotation shaft 72B. The lower left-right fin 7B corresponds to a lower fin. Although not shown, a plurality of upper left-right fins 7A are provided side by side in the left-right direction, and a plurality of lower left-right fins 7B are also provided side by side in the left-right direction.

In each of the upper left-right fins 7A, the ends of the rotation shaft 72A in the up-down direction are respectively inserted into the hole 12 and the hole 14. Each of the upper left-right fins 7A can adjust the direction in which conditioned air is blown out from the upper flow path 16 (upper opening 17) in the left-right direction by rotating about the rotation shaft 72A.

In each of the lower left-right fins 7B, the ends of the rotation shaft 72B in the up-down direction are respectively inserted into the hole 13 and the hole 15. Each of the lower left-right fins 7B can adjust the direction in which conditioned air is blown out from the lower flow path 18 (lower opening 19) in the left-right direction by rotating about the rotation shaft 72B.

The rear end of each of the lower left-right fins 7B is located forward of the curved surface 52, and more specifically, is located forward of the lower end of the curved surface 52. This can suppress the lower left-right fins 7B from being visible to the driver or the like.

The up-down fin 8 adjusts the direction of flow of conditioned air up and down. The up-down fin 8 is disposed in front of the partition 3 inside the case 2. The up-down fin 8 includes a blade 81 that is formed in a rectangular plate shape and whose plate surface is disposed along the left-right direction, and a rotation shaft 82 that passes through the blade 81 and rotates about a central axis line extending in the left-right direction.

The blade 81 is bent at the position of the rotation shaft 82, and more specifically, bent at an obtuse angle so as to be convex upward. The dimension from the rear end of the blade 81 to the rotation shaft 82 is smaller than the dimension from the front end of the blade 81 to the rotation shaft 82. The blade 81 is rotatable about a central axis line of the rotation shaft 82. In the blade 81, a part on the front side of the rotation shaft 82 is referred to as a first part 81a, and a part on the rear side of the rotation shaft 82 is referred to as a second part 81b.

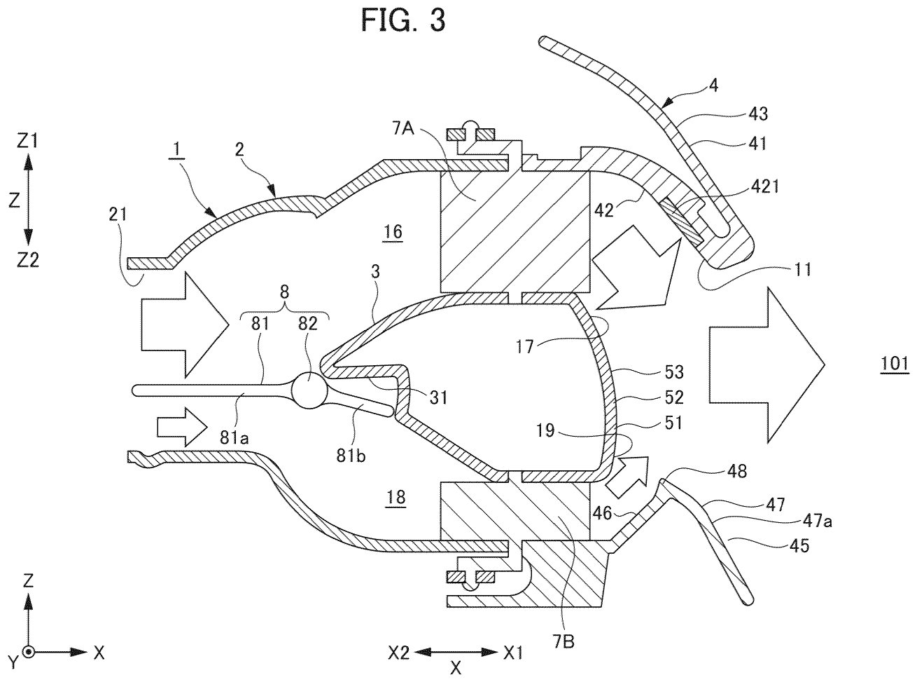

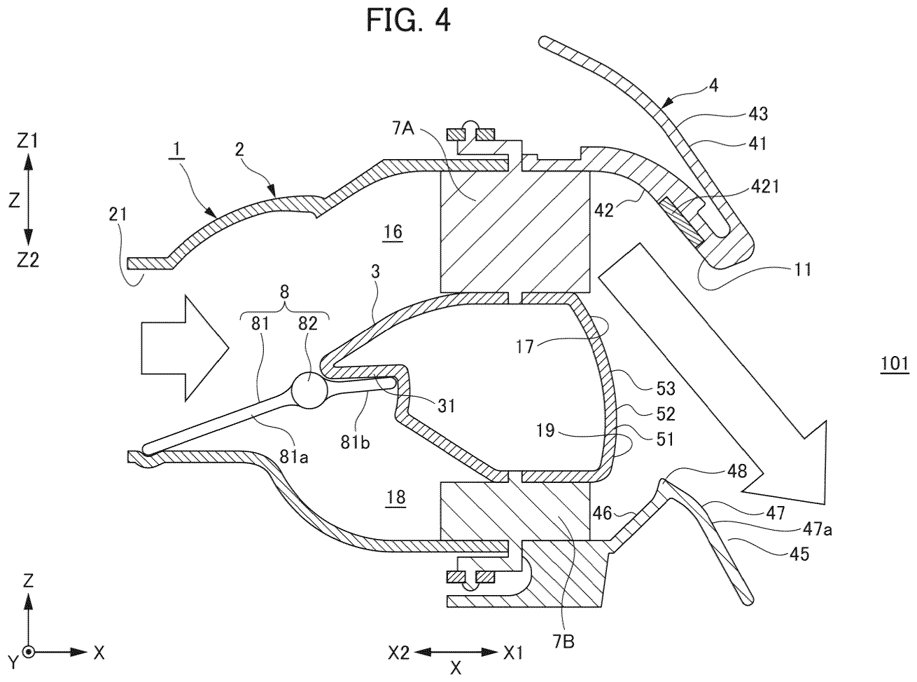

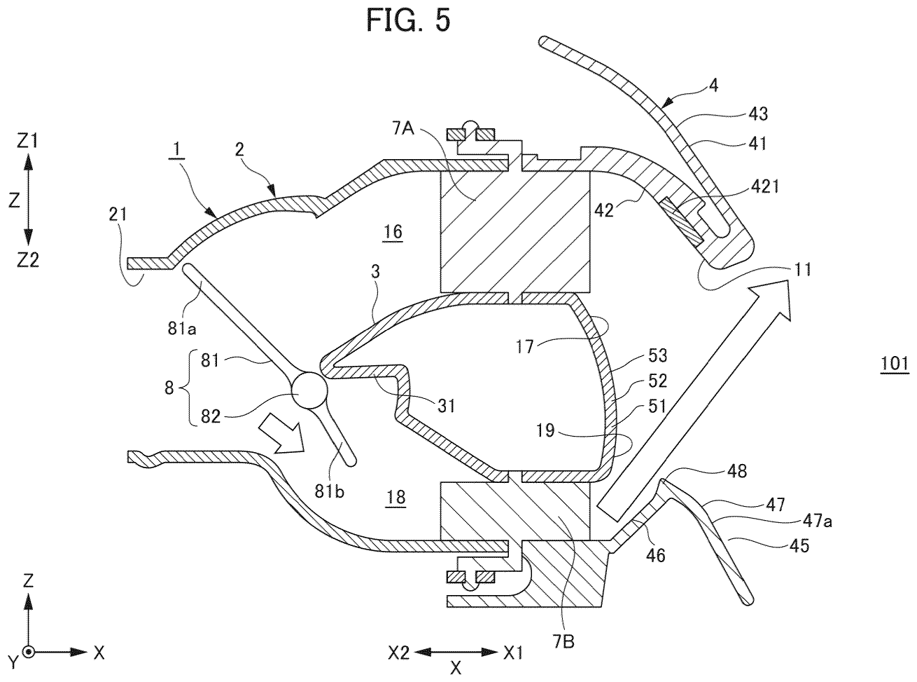

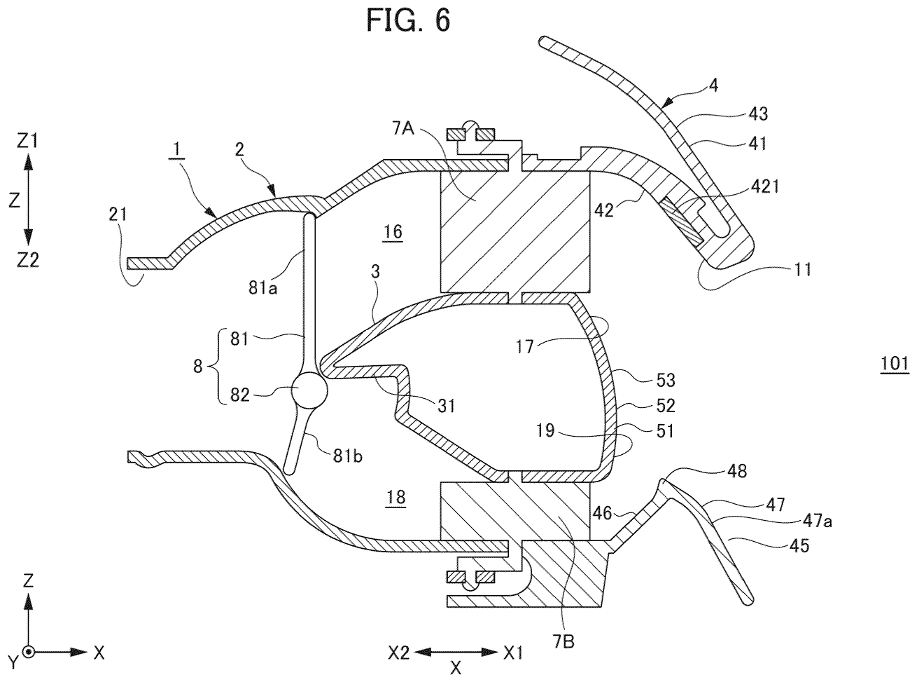

The up-down fin 8 can take a first state (see FIG. 3) in which both the upper flow path 16 and the lower flow path 18 are opened and the plate surface of the first part 81a is substantially horizontal, a second state (see FIG. 4) in which the first part 81a closes the lower flow path 18, a third state (see FIG. 5) in which the first part 81a closes the upper flow path 16, and a fourth state (see FIG. 6) in which the first part 81a closes the upper flow path 16 and the second part 81b closes the lower flow path 18. The up-down fin 8 can be displaced between the first state, the second state, the third state, and the fourth state by rotating about the central axis line of the rotating shaft 82. The up-down fin 8 can be in an intermediate state between the first state and the second state, an intermediate state between the first state and the third state, or an intermediate state between the third state and the fourth state.

The rotation shaft 82 is provided close to the front end of the partition 3. When the up-down fin 8 is in the first state, the second state, or an intermediate state therebetween, the second part 81b is accommodated in the recessed part 31. In other words, since the partition 3 includes the recessed part 31, interference between the second part 81b and the partition 3 at the time of rotation of the up-down fin 8 is avoided. Thus, the movable range of the up-down fin 8 (blade 81) is secured. Furthermore, since the blade 81 is bent at the position of the rotation shaft 82, interference between the second part 81b and the partition 3 when the blade 81 is in the second state is suppressed.

The opening area of the front side of the lower flow path 18 is smaller than the opening area of the front side of the upper flow path 16. In the up-down fin 8, the dimension from the rear end of the blade 81 to the rotation shaft 82 is smaller than the dimension from the front end of the blade 81 to the rotation shaft 82. Accordingly, the up-down fin 8 can suitably close the upper flow path 16 and the lower flow path 18.

The left-right fin 7 and the up-down fin 8 may be manually operated or electrically operated. The up-down fin 8 is not essential. However, when the up-down fin is not provided in the air blowing structure, it is preferable that the left-right fin is capable of closing the upper flow path 16 and the lower flow path 18.

Next, the flow of conditioned air in the air blowing structure 1 will be described with reference to FIGS. 3 to 6. The flow of conditioned air in the air blowing structure 1 varies depending on the state of the up-down fin 8. Hereinafter, the case where the up-down fin 8 is in the first state, the case where the up-down fin 8 is in the second state, the case where the up-down fin 8 is in the third state, and the case where the up-down fin 8 is in the fourth state will be described. FIG. 3 shows a flow of conditioned air in the air blowing structure 1 when the up-down fin 8 is in the first state. FIG. 4 shows a flow of conditioned air in the air blowing structure 1 when the up-down fin 8 is in the second state. FIG. 5 shows a flow of conditioned air in the air blowing structure 1 when the up-down fin 8 is in the third state. FIG. 6 shows a flow of conditioned air in the air blowing structure 1 when the up-down fin 8 is in the fourth state. In FIGS. 3 to 5, the flow of the conditioned air is indicated by arrows. In FIG. 6, the representation of conditioned air is omitted.

As shown in FIG. 3, when the up-down fin 8 is in the first state, conditioned air flows into the upper flow path 16 and the lower flow path 18. The conditioned air that has flowed into the upper flow path 16 blows out downward and rearward from the upper opening 17. The conditioned air that has flowed into the lower flow path 18 blows out upward and rearward from the lower opening 19. The conditioned air blown out from the upper opening 17 and the conditioned air blown out from the lower opening 19 combine and blow out from the outlet 11. In this case, the direction in which the conditioned air blows out from the outlet 11 is an intermediate direction between the direction in which conditioned air blows out from the outlet 11 when the up-down fin 8 is in the second state and the direction in which conditioned air blows out from the outlet 11 when the up-down fin 8 is in the third state, as viewed in the up-down direction, and more specifically, the direction in which conditioned air hits the range from the face to the thigh of the body of the driver or the like.

As shown in FIG. 4, when the up-down fin 8 is in the second state, conditioned air flows only into the upper flow path 16. The conditioned air flowing into the upper flow path 16 blows out downward and rearward from the upper opening 17. The conditioned air blows out downward and rearward from the outlet 11. As described above, by setting the up-down fin 8 to the second state, the direction in which conditioned air blows out from the outlet 11 can be adjusted downward. When the up-down fin 8 is in the second state, the direction in which conditioned air blows out from the outlet 11 is set, for example, such that a part of the conditioned air deviates upward above the driver or the like. In this case, the volume of conditioned air that hits the driver or the like can be reduced.

When the conditioned air passes through the vicinity of the curved surface 52, the conditioned air is slightly drawn toward the curved surface 52 by the Coanda effect. This enhances the downward directivity of the conditioned air. When the conditioned air passes through the vicinity of the inclined surface 47a, the conditioned air is slightly drawn toward the inclined surface 47a by the Coanda effect. This further enhances the downward directivity of the conditioned air.

As shown in FIG. 5, when the up-down fin 8 is in the third state, conditioned air flows only into the lower flow path 18. The conditioned air flowing into the lower flow path 18 blows out upward and rearward from the lower opening 19. The conditioned air blows out upward and rearward from the outlet 11. As described above, by setting the up-down fin 8 to the third state, the direction in which conditioned air blows out from the outlet 11 can be adjusted upward.

When the conditioned air passes through the vicinity of the curved surface 52, the conditioned air is slightly drawn toward the curved surface 52 by the Coanda effect. This enhances the upward directivity of the conditioned air. The upward directivity of conditioned air is enhanced by providing the return part 48 in the lower opening 19.

The lower flow path 18 is narrower than the upper flow path 16. Therefore, the volume of conditioned air blowing out from the outlet 11 when the up-down fin 8 is in the third state is smaller than that when the up-down fin 8 is in the second state. When the up-down fin 8 is in the first state, the conditioned air blowing out from the outlet 11 is a combination of the conditioned air having passed through the upper flow path 16 and the conditioned air having passed through the lower flow path 18. Therefore, the volume of conditioned air blowing out from the outlet 11 is maximized when the up-down fin 8 is in the first state.

As shown in FIG. 6, when the up-down fin 8 is in the fourth state, both the upper flow path 16 and the lower flow path 18 are closed by the up-down fin 8. In this case, conditioned air does not flow into either the upper flow path 16 or the lower flow path 18. Therefore, by setting the up-down fin 8 to the fourth state, it is possible to stop the blowing of conditioned air from the air blowing structure 1.

As described above, the air blowing structure 1 can adjust the direction of flow and the volume of the conditioned air supplied into the vehicle interior 101 by changing the state of the up-down fin 8.

The air blowing structure 1 according to the present embodiment achieves the following effects.

(1) According to the present embodiment, the opening area of the lower opening 19 is smaller than the opening area of the upper opening 17. By reducing the opening area of the lower opening 19, it is possible to suppress the opening of the lower opening 19 from being visible to the driver or the like. Thus, the air blowing structure 1 having an excellent aesthetic appearance can be provided.

In addition, by increasing the opening area of the upper opening, it is possible to secure the volume of the conditioned air supplied from the outlet 11 into the vehicle interior 101 without impairing the aesthetic appearance.

(2) According to the present embodiment, the lower opening 19 is provided with the return part 48 protruding forward. This can make the opening of the lower opening 19 less visible to the driver or the like. In addition, the upward directivity of the conditioned air blown out from the lower opening 19 can be enhanced.

(3) According to the present embodiment, at least a part of the upper panel 41 is located rearward of the return part 48. This can suppress the opening of the lower opening 19 from being visible to the driver or the like.

(4) According to the present embodiment, the lower panel 45 includes the inclined surface 47a that extends downward and rearward from the opening periphery of the outlet 11. Accordingly, the conditioned air blown out downward from the outlet 11 is attracted to the second lower inclined part 47 by the Coanda effect. This can enhance the downward directivity of the conditioned air.

(5) According to the present embodiment, the curved surface 52, which is provided between the upper opening 17 and the lower opening 19 on the front side of the outlet 11 and is curved in a convex shape toward the rear. In this case, the conditioned air blown upward is attracted to the lower part of the curved surface 52 by the Coanda effect. This can enhance the upward directivity of the conditioned air. The conditioned air blown downward is attracted to the upper part of the curved surface 52. This can enhance the downward directivity of the conditioned air.

(6) According to the present embodiment, the rear end of the lower left-right fin 7B is located forward of the curved surface 52. This can suppress the lower left-right fin 7B from being visible to the driver or the like.

(7) According to the present embodiment, the curved surface 52 includes the decorative part 53. This can enhance the design of the air blowing structure 1. In addition, it is possible to attract the attention of the driver or the like to the decorative part 53 and make the other parts relatively inconspicuous.

The upper panel 41 (first upper inclined part 42) includes a light projector 421 that projects light toward the decorative part 53. This allows the decorative part 53 to be illuminated and emphasized, further enhancing the design of the air blowing structure 1 and more suitably attracting the attention of the driver or the like to the decorative part 53.

Although the preferred embodiments of the present invention have been described above, the present invention is not limited to the above-described embodiments and can be modified as appropriate.

In the above embodiment, the air blowing structure 1 is provided on the front side of the vehicle interior 101, but may be provided on the left side or the right side of the vehicle interior 101, for example. Although the downstream direction is the rearward direction in the above embodiment, the downstream direction may be the leftward direction or the rightward direction.

In the above-described embodiment, the air blowing structure 1 supplies the conditioned air generated by the air conditioning device into the vehicle interior 101, but the present invention is not limited thereto. For example, the air blowing structure may supply outside air or inside air of the vehicle into the vehicle interior as it is. That is, the air supplied to the vehicle interior by the air blowing structure is not limited to conditioned air.

### EXPLANATION OF REFERENCE NUMERALS

1 air blowing structure
7B lower left-right fin (lower fin)
11 outlet
16 upper flow path
17 upper opening
18 lower flow path
19 lower opening
41 upper panel
45 lower panel
47a inclined surface
48 return part
52 curved surface
53 decorative part
100 vehicle
101 vehicle interior
421 light projector

What is claimed is:

1. An air blowing structure comprising an outlet for supplying air to a vehicle interior of a vehicle,
wherein, among directions orthogonal to an up-down direction, a direction in which the air blows out from the outlet is a downstream direction, and a direction opposite to the downstream direction is an upstream direction,
the air blowing structure further comprising:
an upper panel constituting an upper edge of an opening of the outlet;
a lower panel constituting a lower edge of the opening of the outlet;
an upper flow path through which the air passes; and
a lower flow path that is provided below the upper flow path and through which the air passes,
wherein the upper flow path comprises an upper opening that opens downward and that supplies the air to the vehicle interior through the outlet,
wherein the lower flow path comprises a lower opening that opens upward and that supplies the air to the vehicle interior through the outlet, and
wherein the lower opening has an opening area smaller than an opening area of the upper opening.

2. The air blowing structure according to claim 1, wherein the lower opening comprises a return part protruding in the upstream direction.

3. The air blowing structure according to claim 2, wherein at least a part of the upper panel is located in the downstream direction with respect to the return part.

4. The air blowing structure according to claim 1, wherein the lower panel comprises an inclined surface that extends downward and in the downstream direction from an opening periphery of the outlet.

5. The air blowing structure according to claim 1, further comprising a curved surface that is provided between the upper opening and the lower opening in the upstream direction with respect to the outlet and that is curved in a convex shape in the downstream direction.

6. The air blowing structure according to claim 5,
wherein the air blowing structure further comprises a lower fin that is provided in the lower flow path and that changes a direction of flow of the air, and
wherein the lower fin has an end in the downstream direction that is located in the upstream direction with respect to the curved surface.

7. The air blowing structure according to claim 5,
wherein the curved surface comprises a decorative part, and
wherein the upper panel comprises a light projector that projects light toward the decorative part.
